(19) United States
(12) Patent Application Publication
(10) Pub. No.: US 2010/0253323 A1
(43) Pub. Date: Oct. 7, 2010

(54) MAGNETIC WASHING FOR BIOSENSOR

(75) Inventors: Femke Karina De Theije, Eindhoven (NL); Dominique Maria Bruls, Eindhoven (NL); Thea Van Der Wijk, Eindhoven (NL); Coen Adrianus Verschuren, Eindhoven (NL); Albert Hendrik Jan Immink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/746,182

(22) PCT Filed: Dec. 4, 2008
(86) PCT No.: PCT/IB08/55096

§ 371 Date: Jun. 4, 2010

(30) Foreign Application Priority Data
Dec. 7, 2007 (EP) 07122656.7

(51) Int. Cl. G01N 27/74

(52) U.S. Cl. 324/204

(57) ABSTRACT

Detecting magnetized or magnetizable target components in a fluid containing the magnetized or magnetizable target components amongst other magnetized or magnetizable components, uses a magnetic field generator (M1, 28) to attract the magnetized or magnetizable components towards a binding surface. A magnetic field controller (C1) applies the magnetic field to concentrate the magnetized or magnetizable components in columns on the binding surface, subsequently reduces the magnetic field to enable the columns to collapse, to allow more components to reach the binding surface, and reapplies the magnetic field so as to cause other components to be pulled off the binding surface to reform columns based on the bound target components. A surface sensitive sensor (S1, 26, 29) detects the bound magnetized or magnetizable target components. The reapplication of the magnetic field acts as a magnetic washing step to release unwanted aspecific adsorption binding, leaving the targets, to improve sensitivity with simplified hardware and a reduction in cost and size.

### FIELD OF THE INVENTION

This invention relates to sensing devices for detecting magnetized or magnetizable target components in a fluid containing the magnetized or magnetizable target components amongst other magnetized or magnetizable components, to corresponding methods of detecting, to software for use in controlling such devices and to corresponding methods of manufacturing such devices.

### BACKGROUND TO THE INVENTION

It is known to use biochemical and medicinal diagnostic assays, such as protein microarrays or other methods, to determine interactions between microbiological entities such as viruses, protozoa, bacteria, organelles thereof, liposomes and bioactive molecules such as proteins or DNA.

US 2005/0048599 A1 discloses a method for the investigation of microorganisms that are tagged with particles such that a (e.g. magnetic) force can be exerted on them. In one embodiment of this method, a light beam is directed through a transparent material to a surface where it is totally internally reflected. Light of this beam that leaves the transparent material as an evanescent wave is scattered by microorganisms and/or other components at the surface and then detected by a photodetector or used to illuminate the microorganisms for visual observation.

US2006205093 describes that a challenge of biosensing is to detect small concentrations of specific target molecules (e.g. tumor markers in the pmol/l range and lower) in a complex mixture (e.g. blood) with high concentrations of background material (e.g. mmol/l of albumin). One common biosensing method is to coat a surface with capture molecules (e.g. antibodies, nucleic acids, etc.). These molecules capture the targets which are subsequently detected. The detection of target molecules can be performed with or without a label. The labeling step can occur before or after the capture on the surface. The label can be directly coupled to the target, or indirectly, e.g. via another bio-active molecule. Most frequently optical labels are used for detection, e.g. fluorescent molecules.

An important problem in biosensing is non-specific binding of a detection label or a target molecule, to the surface or to the capture molecules of the biosensor. This generates a background signal, which reduces the analytical sensitivity and specificity of the biosensor. In diagnostic assays, non-specific binding can be reduced by using stringency procedures. Stringency procedures aim to release unwanted aspecific adsorption binding, and only maintain the specific interactions between capture molecules and (labeled) target molecules. The most common stringency method is a washing step. The composition and temperature of the washing solution is carefully tuned to reduce the background for a given assay.

There is an increasing focus on multi-analyte detection, where many different molecules are simultaneously measured on a single surface, called a biochip or (micro)array. The biochip surface is composed of many spots (“capture spots”), every spot comprising a different capture molecule or molecules. It is difficult to develop stringent whole-chip washing steps for multi-analyte sensors, because a multitude of possible background signals need to be suppressed, while a range of different specific interactions has to remain undisturbed, and the native state of different target and capture molecules has to be preserved. The result is a lower analytical sensitivity and a lower analytical specificity. The multi-analyte stringency problem is very serious for protein detection, because proteins and protein-protein interactions are very heterogeneous, and the effect of a certain washing step on the denaturation of proteins and on protein-protein interaction can be very significant.

This major drawback of protein arrays or microarrays has been recognized in the article of Macbeatch and Schreiber (2000) in Science 289, 1760-1763, describing the application of native proteins on microscopic glass slides. Aspecific protein-protein binding is reduced by adding BSA on the capture molecules, prior to the binding with target molecules. A review article of December 2002 (Macbeath (2002) Nature Genetics 32, 5526-532) on protein microarray technology mentions the problem of assessing specificity as a key feature of protein array technology without suggesting potential solutions. The most successful applications of protein array technology up to now are achieved in the field of immunology. The high binding strength between antigen and antibody allows stringent washing conditions to overcome aspecific interactions of antigen and antibody.

A chemical way to address the stringency problem is by designing capture molecules that can interact more strongly and more specifically with the targets. An example is photo-aptamers, synthetic capture molecules that carry photo-reactive groups which can cross-link at specific sites of the target molecule (reviewed in Brody & Gold (2000) J. Biotechnol. 7, 5-13). When a capture surface comprising photo-aptamers is exposed to the sample and a photo-excitation step is applied, molecules that fit the aptamer binding site become covalently linked thereto. Subsequently a severe washing step can be applied to remove molecules that have not photo-reacted. Disadvantages of the photo-aptamer approach are that it requires the design of a new photoaptamer for every target, that a photo-excitation step is required, that the photo-crosslinking step itself does not distinguish between specifically and aspecifically bound molecules, and that it is an endpoint detection method.

US2006205093 describes determining interaction between bioactive molecules using at least a first particle or microcarrier e.g. a bead, and a second particle which may also be a microcarrier, e.g. a second bead. At least the first microcarrier is magnetic. When two beads are used and both beads are magnetic, the beads preferably differ in the size of their magnetic moment. A magnetic field is provided for placing a binding between bioactive molecules under stress to thereby distinguish between bindings of different strengths. In one aspect, the second bead, (with a larger magnetic moment) is used to magnetically remove target molecules linked to beads with smaller magnetic moment which are weakly bound to a capture molecule (itself generally coupled to a mobile or immobile surface).

### SUMMARY OF THE INVENTION

An object of the invention is to provide improved sensing devices for detecting magnetized or magnetizable target components in a fluid containing the magnetized or magnetizable target components amongst other magnetized or magnetizable components, corresponding methods of detecting, software for use in controlling such devices and corresponding methods of manufacturing such devices.

According to a first aspect, the invention provides:

A sensing device for detecting magnetized or magnetizable target components in a fluid containing the magnetized or magnetizable target components amongst other magnetized or magnetizable components, the device having:

a magnetic field generator arranged to provide a magnetic field to attract the magnetized or magnetizable components towards a binding surface suitable to selectively bind the target components,

a magnetic field controller arranged to control the magnetic field generator so as to apply the magnetic field to concentrate the magnetized or magnetizable components in columns on the binding surface, subsequently to reduce the magnetic field to enable the columns to collapse, to allow more of the magnetized or magnetizable target components from the columns to bind to the binding surface, and to reapply the magnetic field so as to cause other magnetized or magnetizable components to be pulled off the binding surface to reform columns based on the bound target components, and

a surface sensitive sensor for detecting the magnetized or magnetizable target components bound to the binding surface.

Such a reapplication of the magnetic field (that was initially used to attract the magnetized or magnetizable target components to the detection surface) can have the surprising effect of acting as a magnetic washing step to release unwanted weak or aspecific adsorption binding, and only maintain the specific binding between receptors and the target components. Previously it was thought that such a washing step needed a pumping step or a second magnetic field generator on the opposite side of the binding surface, to attract the unwanted magnetized or magnetizable components in the opposite direction. So it is surprising to find that this can be achieved by the same magnetic field generator that was initially used for attracting the beads towards the sensor surface, and so enable simplifying the hardware and enable a reduction in cost and size.

Furthermore, the reapplication of the magnetic field can enable the detection reading to reach a stable level more quickly than otherwise, and so enable faster operation, or more sensitive detection of concentrations than relying only on a gradient of the detection over time.

Another aspect provides a method of detecting magnetized or magnetizable target components in a fluid containing the magnetized or magnetizable target components amongst other magnetized or magnetizable components, the method having the steps of:

applying a magnetic field to attract the magnetized or magnetizable components towards a binding surface, to concentrate the magnetized or magnetizable components in columns on the binding surface, reducing the magnetic field to enable the columns to collapse, to allow more of the magnetized or magnetizable target components from the columns to bind to the binding surface, and reapplying the magnetic field so as to cause other magnetized or magnetizable components to be pulled off the binding surface to reform columns based on the bound target components, and

detecting the magnetized or magnetizable target components bound to the binding surface, e.g. via a surface sensitive detection method.

Embodiments of the apparatus or the method can have any additional features, some of which are set out in the claims, and described in more detail below. One such additional feature is the magnetic field generator comprising a permanent magnet and the controller working with or comprising a mechanical arrangement for moving the permanent magnet. Another such additional feature is the magnetic field generator comprising an electro-magnet, and the controller comprising a circuit for controlling a current through the electro-magnet.

Another such feature is the device comprising a chamber for retaining the fluid, the chamber having the binding surface. The chamber can be an integral part of the device, or a removable part. Another such feature is the device having multiple binding surfaces, each suitable for binding a different target component. Another such feature is the device being arranged to detect the different target components. This can involve moving the binding surfaces relative to the sensor, or having multiple sensors.

Another such feature is the sensor or sensors comprising an optical detector. An alternative is a magnetic field detector such as a GMR type detector, for detecting an amount of magnetic field caused by the magnetized or magnetizable target components at the binding surface. The optical detector can comprise a reflection detector arranged to detect an amount of light reflected from a back side of the binding surface. This can be arranged to for total internal reflection at the back side. The optical detector can be arranged to detect fluorescence emitted by the target components at the binding surface. The optical detector can comprise a transmission detector arranged to detect an amount of light transmitted through the binding surface Another such feature is the detector being arranged to take a number of readings at different times and having a processor for deriving results from the readings. Another such feature is the reapplication of the magnetic field being sufficiently strong to distinguish between specific and aspecific binding. Another such feature is microfluidic elements for moving and controlling the fluid.

Any of the additional features can be combined together and combined with any of the aspects. Other advantages will be apparent to those skilled in the art, especially over other prior art. Numerous variations and modifications can be made without departing from the claims of the present invention. Therefore, it should be clearly understood that the form of the present invention is illustrative only and is not intended to limit the scope of the present invention.

### BRIEF DESCRIPTION OF THE DRAWINGS

How the present invention may be put into effect will now be described by way of example with reference to the appended drawings, in which:

FIG. 1 shows a device according to an embodiment of the invention,

FIG. 2 shows another device according to an embodiment,

FIG. 3 shows method steps according to an embodiment, and

FIG. 4 shows a graph of detection values over time, for various concentrations of a target component, together with insets a) to d) showing schematic views of the magnetized or magnetizable components near the binding surface at four stages during the operation.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

The term “comprising”, used in the claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

### INTRODUCTION TO THE EMBODIMENTS

The embodiments described show methods, apparatus and tools for determining the interaction or binding between entities such as microbiological entities, e.g. bioactive molecules. They show methods wherein discrimination can be made between bindings of different strengths such as between specific and aspecific bindings. The discrimination between specific and aspecific binding is especially used in accordance with the present invention with multi-analyte sensors where it can simultaneously detect a wide range of target components such as target molecules. The devices and methods can be used, for example, for protein multi-analyte sensors since modifying buffer conditions to improve stringency on the multi analyte sensor can only be done within very narrow limits. Furthermore it can be of practical use in micro-array and micro-fluidic set-ups, using miniature integrated fluidics and integrated circuit devices, as the methods can be downscaled without loss of sensitivity.

Embodiments of a microelectronic sensing device according to the present invention can serve for the qualitative or quantitative detection of target components comprising label particles attached to target molecules. The target components may for example be biological substances like biomolecules, complexes, cell fractions or cells. Examples are proteins, nucleic acids such as DNA or RNA, genomes or genomic fragments, cDNA, enzymes, carbohydrates, antibodies or antibody fragments, receptors, cells or cellular components such as cell membranes or cell organelles, cell lysates, viruses, bacteria, protozoa, etc. The term “label particle” shall denote a particle (atom, molecule, complex, nanoparticle, microparticle etc.) that has some property (e.g. optical density, magnetic susceptibility, electrical charge, fluorescence, radioactivity, etc.) which can be detected, thus indirectly revealing the presence of the associated target molecule. The “target molecule” can itself act as a “label particle” in come cases.

The sensing device can work with removable carriers such as vessels or chambers which have the binding surface at which target components can collect, or carrier and its binding surface may be an integral part of the sensing device. The term “binding surface” is chosen here primarily as a unique reference to a particular part of the surface of a fluid carrier, and though the target components will in many applications actually bind to said surface, this does not necessarily need to be the case. All that is required is that the target components can reach the binding surface to collect there (typically in concentrations determined by parameters associated to the target components, to their interaction with the binding surface, to their mobility and the like). Where the sensor uses optical detection, the carrier can in some cases have a high transparency for light of a given spectral range, particularly light emitted by the light source that will be defined below. The carrier may for example be produced from glass or some transparent plastic.

In order to reach an effective evaluation of biomaterial components, the biomaterial has to be brought into close contact to the surface of the biosensor. When magnetic labels are used, this can be realised by magnetic attraction. Magnetic attraction is often useful to achieve a desired level of sensitivity in a short time. As it speeds up the concentration at the binding surface, therefore the binding process of the magnetic particles at the sensor surface is accelerated. Secondly, magnetic washing can replace the traditional wet washing step, which is more accurate and reduces the number of operating actions. This second magnetic step for washing away the other components is generally performed by using a (additional/separate) magnet (permanent or coil) above the binding surface. In this step, all remaining ‘free’ magnetic particles are entirely removed from the liquid or medium in which the bio-measurement is performed.

A problem with this is that in order to perform magnetic attraction and magnetic washing, two separate magnetic systems are needed, or a coil that is designed such that it can be switched between attraction and repulsion using mechanical or electromechanical means. This set-up would be relatively complex.

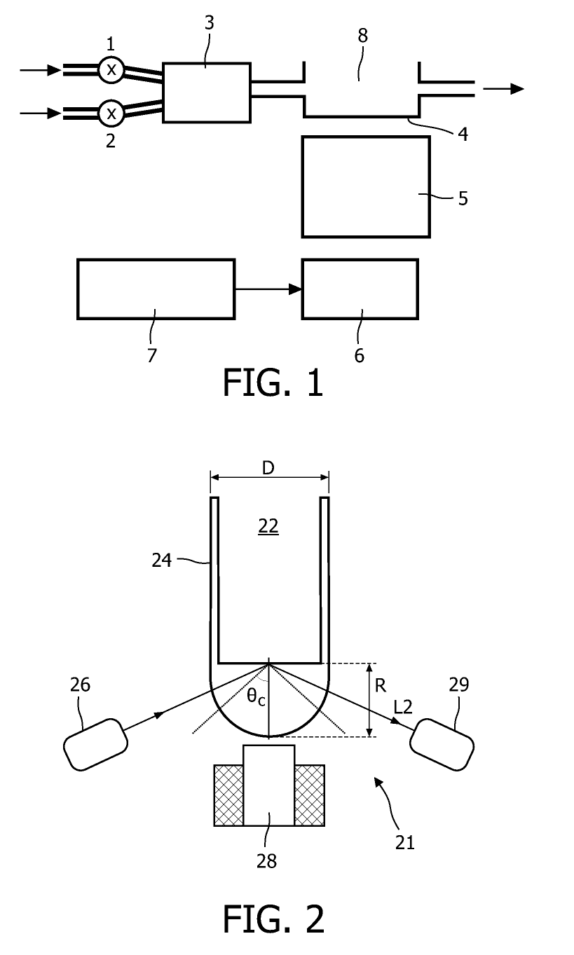

### FIGS. 1, 2 Sensing Devices According to Embodiments of the Invention

According to the embodiments, a solution for biosensors that have surface sensitive detectors, is an alternative magnetic washing step.

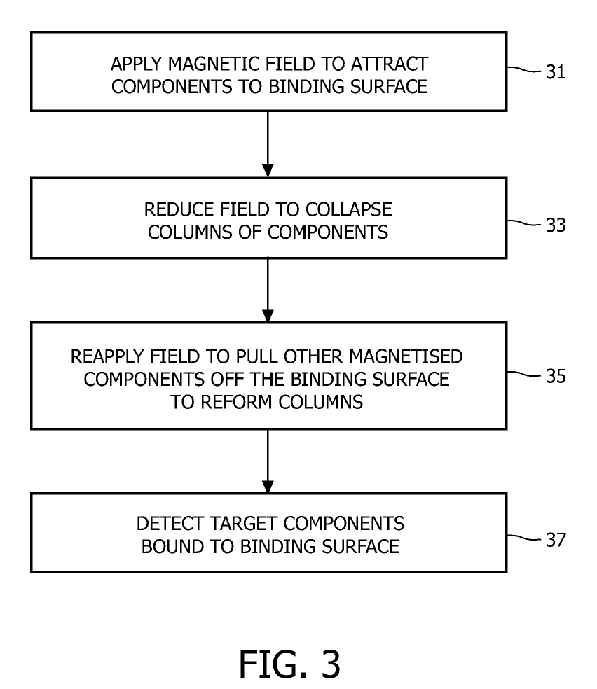

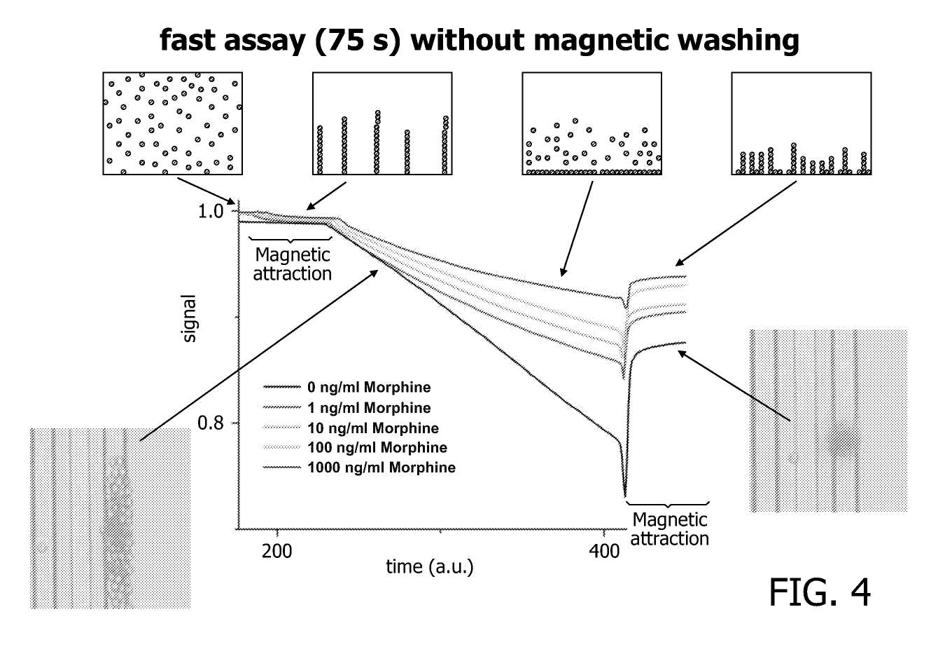

FIG. 1 shows an example of a sensing device having a fluid path from left to right controlled by valves v1 (1) and v2 (2), a pump P1 (3), and a binding surface (4) (or array of binding surfaces, at the bottom of a chamber (8). A sensor S1 (5) or an array of such sensors is provided near the binding surface, typically below, but not necessarily. The sensors can be optical, mechanical, radioactivity or magnetic field sensors for example. A magnet M1 (6) is arranged to cause a magnetic field to attract the magnetized or magnetizable components in the fluid, towards the binding surface. The magnet is controlled by a controller C1 (7), to follow steps described below with reference to FIGS. 3 and 4. The controller (7) can be implemented by conventional processing circuitry or software running on conventional hardware, and for use with a permanent magnet, can include means for causing or allowing movement of the permanent magnet relative to the binding surface. Alternatively, if an electromagnet or electromagnets is/are used the controller may control current to the electromagnet/electromagnets to thereby control the strength of the magnetic field, its direction and/or its position. The timing of the control of magnetic field can be coordinated with timing of the sensing, timing of control the fluidic elements and other parts.

FIG. 2 shows another embodiment having a removable carrier in the form of a well, such as a polymer, e.g. polystyrene well 22 having a binding surface at the bottom. The sensing device has a substrate 21, carrying a movable permanent magnet 28, and has or is associated with a sensor in the form of a light source 26 and has or is associated with a photodetector 29. To enable total internal reflection at a backside of the binding surface, there is a transparent hemisphere 24 of glass arranged with its flat surface against the back side of the binding surface, and its curved side facing downwards so that the light from the light source enters and leaves the hemisphere perpendicular to its surface to minimize reflections and enable better detection accuracy.

This sensor uses, for example, an optical read-out method based on frustrated total internal reflection (F-TIR) combined with magnetic attraction as will now be described.

### FIGS. 3, 4, Method Steps According to Embodiments.

FIG. 3 shows some of the principal method steps. At step 31, a magnetic field is applied to attract magnetized or magnetizable components in a fluid towards the binding surface. This has the effect of causing columns of magnetized or magnetizable components to build up, as is known, but is usually regarded as hindering biological binding and detection Paramagnetic components are preferred. With the magnetic field applied, magnetizable (e.g. paramagnetic) components become magnetized along the field lines, causing them to pile up into columns. Components which are magnetized independent of the field, such as permanent magnets, will also align into columns with a preferred direction along the field lines. Such components are less preferred as they can cluster inside the liquid, and might not ‘collapse’ so easily when the field is switched off. At step 33, the field is reduced sufficiently to allow the columns to collapse. The field strength and duration of the reduction, appropriate to achieve this can be determined easily and will depend on the magnetization and other characteristics of the components, the viscosity of the fluid, the location of the magnet and so on. Subsequently, at step 35, the field is reapplied with sufficient strength to pull the other magnetized or magnetizable components off the binding surface but leave the target components which are bound to the binding surface. This causes the columns of components to be rebuilt, based on the target components which are bound to the binding surface. Again the field strength and duration of the reapplication, appropriate to achieve this can be determined easily in practice and will depend on the strength of the binding, the magnetization and other characteristics of the components, the viscosity of the fluid, the location of the magnet and so on. At step 37, the sensor is used to detect the target components bound to the binding surface. The sensitivity of the detection can be increased since there are fewer other magnetized or magnetizable components on the binding surface. The detection can be carried out over a predetermined time period, and readings before the reapplication of the magnetic field can be used as well as readings during and after the reapplication. The readings can be processed to calibrate them, to take averages, to correlate with times of reduction and reapplication and so on. This can be done by on board integrated circuitry, or by an external computer such as a personal computer or microcontroller. A processed detection output can be in the form of a positive/negative binary result, or in the form of a degree of concentration for example.

Where the magnet is a permanent magnet, the application, reduction and reapplication of the magnetic field will involve moving the magnet relative to the binding surface. In some embodiments it may be easier to move the carrier rather than move the magnet. Where the magnet is an electromagnet, the field can be controlled by circuitry, e.g. in the controller, for varying the current in the magnet.

FIG. 4 shows a graph of readings from the sensor for a number of different concentrations. It is based on an experimental set-up for assay experiments with optical detection and magnetic actuation, as shown in FIG. 2. Upon actuation, the permanent magnet is placed under the well by mechanical movement. The distance between the bottom of the well and the magnet is about 2 mm. Smaller distances, e.g. in the order of 1 mm or less are also preferred. These can be achieved by using a non-complete hemisphere. Clearly any of the parameters described for this embodiment are not limiting, and other parameters and variations can be used.

FIG. 4 shows a dose-response curve on polystyrene wells coated with 10 pg/ml BSA-morphine. Magnetized or magnetizable components in the form of magnetic particles (MPs) functionalized with anti-morpine antibodies premixed with a defined amount of free morphine solved in PBS+10 mg/ml BSA+0.65% Tween-20 were inserted into the wells (1:20 dilution of MPs, total amount of solution was 40 μl, final morphine concentrations between 1 and 1000 ng/ml). MPs were actuated using a permanent magnet below the well for 15 seconds, to up-concentrate the MPs near the surface. Next, the magnet was removed and the MPs were allowed to bind to the surface for 60 seconds. The data show that already after 20 seconds the binding rate of magnetic particles to the surface is a direct measure for the concentration of free morphine in solution (as shown in FIG. 4). Surprisingly, upon the next magnetic attraction step, the signal increases during this second actuation step, and reaches a stable level that is a good measure for the morphine concentration in the well.

The results can be understood as follows: first beads are injected and homogeneously distributed over the solution (see inset a, FIG. 4). Upon magnetic actuation, MPs are concentrated to the surface, without showing a large increase in binding to the surface (no signal decrease; see inset b, FIG. 4, corresponding to step 31 of FIG. 3) The magnetic beads will align in columns or pillars perpendicular to the surface, and the number of beads on the surface, and thus detected by the system, is low. Upon removing of the magnetic field, the signal drops indicating MPs binding to the surface (inset c in FIG. 4 corresponding to step 33 of FIG. 3). After the 60 seconds free binding, the magnet is again placed under the well. Upon this magnetic attraction, first MPs will be up-concentrated near the surface. Next, all magnetized or magnetizable MPs will align in pillars, starting from the MPs bound on the surface. At least a large fraction of the MPs that are aspecifically bound to the surface, and at least a reasonable fraction of MPs free in solution, will be collected in these pillars (see inset d in FIG. 4, corresponding to step 35 of FIG. 3). In this way, aspecifically bound MPs are removed from the surface and an end-point measurement is performed with only bound MPs on the surface, and without needing an extra top magnet (note that the optical probing method using the evanescent field is a true surface sensitive method, thus only the beads that are actually bound to the surface are detected). Thus, after a few seconds of the second magnetic actuation step all unbound MPs are removed from the surface and the signal is stable, representing now only the bound MPs, as only these MPs are detected in the used optical detection scheme.

Although described as a magnetic wash step used for a biosensor based on frustrated total internal reflection (F-TIR) as a read-out method, other kinds of surface sensitive read-out methods (like other surface acoustic wave measurements, optical surface scanning or imaging methods and GMR) can be used. A GMR-based biosensor is describe in WO 2006059270 A2.

### Optical Surface Sensor:

This can have a light source and a light detector, examples of which will now be described in more detail. A light source is provided for emitting a light beam, called “incident light beam” in the following, into the aforementioned carrier such that it is totally internally reflected in an investigation region at the binding surface of the carrier. The light source may for example be a laser or a light emitting diode (LED), optionally provided with some optics for shaping and directing the incident light beam. The “investigation region” may be a sub-region of the binding surface or comprise the complete binding surface; it will typically have the shape of a substantially circular spot that is illuminated by the incident light beam. Moreover, it should be noted that the occurrence of total internal reflection requires that the refractive index of the carrier is larger than the refractive index of the material adjacent to the binding surface. This is for example the case if the carrier is made from glass (n=2) or plastic (n=1.6) and the adjacent material is water (n=1.3). It should further be noted that the term “total internal reflection” shall include the case called “frustrated total internal reflection”, where some of the incident light is lost (absorbed, scattered etc.) during the reflection process.

A light detector for determining the amount of light in a reflected light beam, wherein the term “reflected light beam” can both be a unique reference to the light that is caught by the detector and imply that all light of this beam stems from the aforementioned total internal reflection of the incident light beam. It is however not necessary that the “reflected light beam” comprises all the totally internally reflected light (though this will preferably be the case), as some of this light may for example be used for other purposes or simply be lost.

The detector may comprise any suitable sensor or plurality of sensors by which light of a given spectrum can be detected, for example a photodiode, a CCD sensor, a CMOS image sensor, a photo resistor, a photocell, or a photo multiplier tube or a microscope.

Some embodiments of the microelectronic sensor device can allow a sensitive and precise quantitative or qualitative detection of target components in an investigation region at the binding surface. This is due to the fact that the totally internally reflected incident light beam generates an evanescent wave that extends from the carrier surface a short distance into the adjacent material. If light of this evanescent wave is scattered or absorbed by target components or label particles present at the binding surface, it will be missing in the reflected light beam. The amount of light in the reflected light beam (more precisely the amount of light missing in the reflected light beam when compared to the incident light beam) is therefore an indication of the presence and the amount of target components/labels at the binding surface. One advantage of the described optical detection procedure comprises its accuracy as the evanescent waves explore only a small volume of typically 10 to 300 nm thickness next to the binding surface, thus avoiding disturbances from the bulk material behind this volume. Moreover, most biological samples have refractive indices close to water (n=1.3) and reflection is frustrated only when labels with higher refractive index come within the range of the evanescent field. A high sensitivity is achieved when the reflected light is measured as all effects are detected that reduce the amount of totally internally reflected light. Moreover, the optical detection can optionally be performed from a distance, i.e. without mechanical contact between the carrier and the light source or light detector.

The incident light beam which is transmitted into the carrier 11 arrives at the binding surface at an angle larger than the critical angle θ_{c} of total internal reflection (TIR) and is therefore totally internally reflected as a “reflected light beam”. The reflected light beam leaves the carrier through another surface and is detected by a photo detector 29, e.g. a photodiode. This detects the amount of light of the reflected light beam (e.g. expressed by the light intensity of this light beam in the whole spectrum or a certain part of the spectrum). The measurement results are evaluated and optionally monitored over an observation period by an evaluation and recording module that is coupled to the detector.

Optionally a further light detector can alternatively or additionally be used to detect fluorescence light emitted by fluorescent particles which were stimulated by the evanescent wave of the incident light beam. As this fluorescence light is usually emitted isotropically to all sides, this further detector can in principle be disposed anywhere, e.g. also above the binding surface. Moreover, it is of course possible to use the detector, too, for the sampling of fluorescence light, wherein the latter may for example spectrally be discriminated from reflected light. Though the following description concentrates on the measurement of reflected light, the principles discussed here can mutatis mutandis be applied to the detection of fluorescence, too.

For eliminating or at least minimizing the influence of background (e.g. of the sample fluid, such as saliva, blood, etc.), the detection technique should be surface-specific.

This can be achieved by using the principle of frustrated total internal reflection which is explained in the following.

According to Snell's law of refraction, the angles θ_{A} and θ_{B} with respect to the normal of an interface between two media A and B satisfy the equation

n_{A} sin θ_{A}=n_{B} sin θ_{B}

with n_{A}, n_{B} being the refractive indices in medium A and B, respectively. A ray of light in a medium A with high refractive index (e.g. glass with n_{A}=2) will for example refract away from the normal under an angle θ_{B} at the interface with a medium B with lower refractive index such as air (n_{B}=1) or water (n_{B}≈1.3). A part of the incident light will be reflected at the interface, with the same angle as the angle θ_{A} of incidence. When the angle θ_{A} of incidence is gradually increased, the angle θ_{B} of refraction will increase until it reaches 90°. The corresponding angle of incidence is called the critical angle, θ_{c}, and is given by sin θ_{c}=n_{B}/n_{A}. At larger angles of incidence, all light will be reflected inside medium A (glass), hence the name “total internal reflection”. However, very close to the interface between medium A (glass) and medium B (air or water), an evanescent wave is formed in medium B, which decays exponentially away from the surface. The field amplitude as function of the distance z from the surface can be expressed as:

exp(−k\sqrt{n_{A}² sin²(θ_{A})−n_{B}²}·z)

with k=2π/λ, θ_{A} being the incident angle of the totally reflected beam, and n_{A} and n_{B} the refractive indices of the respective associated media.

For a typical value of the wavelength λ, e.g. λ=650 nm, and n_{A}=1.53 and n_{B}=1.33, the field amplitude has declined to exp(−1)≈0.37 of its original value after a distance z of about 228 nm. When this evanescent wave interacts with another medium like the magnetic particles MPs in the setup of FIG. 1 or FIG. 2, part of the incident light will be coupled into the sample fluid (this is called “frustrated total internal reflection”), and the reflected intensity will be reduced (while the reflected intensity will be 100% for a clean interface and no interaction). Depending on the amount of disturbance, i.e. the amount of magnetic beads on or very near (within about 200 nm) to the binding surface (not in the rest of the sample chamber), the reflected intensity will drop accordingly. This intensity drop is a direct measure for the amount of bound magnetic target components, and therefore for the concentration of target molecules. When the mentioned interaction distance of the evanescent wave of about 200 nm is compared with the typical dimensions of anti-bodies, target molecules and magnetic beads, it is clear that the influence of the background will be minimal Larger wavelengths λ will increase the interaction distance, but the influence of the background liquid will still be very small.

The described procedure is independent of applied magnetic fields. This allows real-time optical monitoring of preparation, measurement and washing steps. The monitored signals can also be used to control the measurement or the individual process steps.

For the materials of a typical application, medium A of the carrier can be glass and/or some transparent plastic with a typical refractive index of 1.52. Medium B in the sample chamber can be water-based and have a refractive index close to 1.3. This corresponds to a critical angle θ_{c} of 60°. An angle of incidence of 70° is therefore a practical choice to allow fluid media with a somewhat larger refractive index (assuming n_{A}=1.52, n_{B} is allowed up to a maximum of 1.43). Higher values of n_{B} would require a larger n_{A} and/or larger angles of incidence.

Advantages of the described optical read-out combined with magnetic labels for actuation can include the following:

Cheap cartridge: The carrier cartridge can consist of a relatively simple, injection-molded piece of polymer material that may also contain fluidic channels.

Large multiplexing possibilities for multi-analyte testing: The binding surface in a disposable cartridge can be optically scanned over a large area. Alternatively, large-area imaging is possible allowing a large detection array. Such an array (located on an optical transparent surface) can be made by e.g. ink-jet printing of different binding molecules on the optical surface.

The method also enables high-throughput testing in well-plates by using multiple beams and multiple detectors and multiple actuation magnets (either mechanically moved or electro-magnetically actuated).

Actuation and sensing are orthogonal: Magnetic actuation of the magnetic particles (by large magnetic fields and magnetic field gradients) does not influence the sensing process. The optical method therefore allows a continuous monitoring of the signal during actuation. This provides a lot of insights into the assay process and it allows easy kinetic detection methods based on signal slopes.

The system is really surface sensitive due to the exponentially decreasing evanescent field.

Easy interface: It can be implemented with no electrical interconnect between cartridge and reader if necessary. An optical window is the only requirement to probe the cartridge. A contact-less read-out can therefore be performed.

Low-noise read-out is possible.

In the environment of a laboratory, well-plates are typically used that comprise an array of many sample chambers (“wells”) in which different tests can take place in parallel. The production of these (possibly disposable) wells is very simple and cheap as a single injection-molding step is sufficient.

The light source can be arranged to produce a parallel light beam, incident at the well bottom surface at an angle larger than the critical angle θ_{c}. To prevent excess reflection of this incident light beam at the first interface from air to the carrier (e.g. glass or plastic material), the bottom of the well comprises a hemispherical shape 24 of radius R, with its centre coinciding with a detection surface which is a backside of the binding surface. The incident light beam is directed towards this same centre. At the reflection side, a photodetector such as a photodiode 29 is positioned to detect the intensity of the reflected light beam. A typical diameter D of the well ranges from 1 to 8 mm.

An alternative for the light source is to include some optical element like a lens (not illustrated) to produce an incident light beam which is substantially focused to the centre of the hemisphere 24. At the detection side, a similar optical element such as a lens can be used to collect and detect the light intensity of the reflected and now diverging light beam.

In a further development of the measuring procedure, multiple incident light beams and reflected light beams can be used to simultaneously detect the presence of different target molecules at different locations in the same well, or in an array of wells. Multiple hemispheres could be provided on the well bottom or on the bottom of the array of wells that can be used to couple the light from multiple incident light beams to respective investigation regions on the bottom of the well. Multiple photodetectors (not shown) may be used in this case to measure the multiple reflected light beams.

Another alternative embodiment has a prism or truncated pyramidal structure in place of the hemisphere to couple the light of the incident light beam and the reflected light beam. The sloped edges of the pyramid should be substantially perpendicular to these light rays. Advantages of this design are that it is simple to produce and does not block beams from neighboring areas. It is possible to use a single, parallel incident light beam with a large diameter to cover all detection areas on the well bottom. As a detector, multiple photodiodes can be used, aligned with each individual detection area. Alternatively, a CCD or CMOS chip (not shown) such as used in a digital camera can be used to image the reflected intensity response of the entire well bottom, including all detection areas. Using appropriate signal processing, all signals can be derived as with the separate detectors, but without the need for prior alignment.

In another further embodiment the well bottom can comprise an open cavity with its center outside the optical path of the incident light beam(s) and the reflected light beam(s). This allows the following advantageous features:

A (T-shaped) ferrite core of a magnetic coil can be used for improved field intensity and concentration, and can be placed close to the binding surface, allowing a compact and low-power design.

A self-aligning structure is achieved: if the optics and the magnetic field generator are fixed, an auto-alignment of the well on the ferrite core takes place.

The magnetized or magnetizable components can be in the form of magnetic beads such as polystyrene spheres filled with small magnetic grains (e.g. of iron-oxide). This causes the beads to be super-paramagnetic. The refractive index of poly-styrene is nicely matched to the refractive index of a typical substrate material of well-plates. In this way optical outcoupling of light is enhanced.

Above has been described a biosensor using a surface sensitive read-out method comprising a new actuation method where piles of magnetic particles are formed on the sensor surface during a second magnetic attraction step. A first magnetic actuation step (the catch-step) is used for up-concentration of MPs near the sensor surface. The true surface sensitivity of the detection causes the signal to decrease during this second magnetic attraction step because the top-part of the piles are not detected. Only the bottom MP of each pile is probed. The fact that actuation is needed only from the bottom makes the system more simple and thus robust. Other variations and additions can be envisaged by those skilled in the art within the scope of the claims.

1. A sensing device for detecting magnetized or magnetizable target components in a fluid containing the magnetized or magnetizable target components amongst other magnetized or magnetizable components, the device having:
a magnetic field generator arranged to provide a magnetic field to attract the magnetized or magnetizable components towards a binding surface suitable to selectively bind the target components,
a magnetic field controller arranged to control the magnetic field generator so as to apply the magnetic field to concentrate the magnetized or magnetizable components in columns on the binding surface, subsequently reduce the magnetic field to enable the columns to collapse, to allow more of the magnetized or magnetizable target components from the columns to bind to the binding surface, and reapply the magnetic field so as to cause other magnetized or magnetizable components to be pulled off the binding surface to reform columns based on the bound target components, and a surface sensitive sensor for detecting the magnetized or magnetizable target components bound to the binding surface.

2. The device of claim 1, the controller being arranged to reapply the magnetic field at a strength sufficient to distinguish between specific and aspecific binding to the binding surface.

3. The device of claim 1, the sensor comprising an optical detector.

4. The device according to claim 1, the magnetic field generator comprising a permanent magnet and the controller comprising a mechanical arrangement for moving the permanent magnet.

5. The device of claim 1 the magnetic field generator comprising an electro-magnet, and the controller comprising a circuit for controlling a current through the electro-magnet.

6. The device of claim 1, comprising a chamber for retaining the fluid, the chamber having the binding surface.

7. The device of claim 1, having multiple binding surfaces, each suitable for binding a different target component.

8. The device of claim 1, the sensor being arranged to detect fluorescence emitted by the target components at the binding surface.

9. The device of claim 1, the detector being arranged to take a number of readings at different times and having a processor for deriving results from the readings.

10. A method of detecting magnetized or magnetizable target components in a fluid containing the magnetized or magnetizable target components amongst other magnetized or magnetizable components, the method having the steps of:
applying a magnetic field to attract the magnetized or magnetizable components towards a binding surface, to concentrate the magnetized or magnetizable components in columns on the binding surface, reducing the magnetic field to enable the columns to collapse, to allow more of the magnetized or magnetizable target components from the columns to bind to the binding surface, and reapplying the magnetic field so as to cause other magnetized or magnetizable components to be pulled off the binding surface to reform columns based on the bound target components, and
detecting the magnetized or magnetizable target components bound to the binding surface.

11. The method of claim 10, the step of reapplying involving reapplying the magnetic field at a strength sufficient to distinguish between specific and aspecific binding to the binding surface.
